(19) United States
(12) Patent Application Publication
(10) Pub. No.: US 2018/0253587 A1
(43) Pub. Date: Sep. 6, 2018

(54) FINGERPRINT SENSOR SYSTEM

(71) Applicant: Zwipe AS, Oslo (NO)

(72) Inventor: Peter Robert Lowe, Peyton, CO (US)

(21) Appl. No.: 15/909,034

(22) Filed: Mar. 1, 2018

Related U.S. Application Data
(60) Provisional application No. 62/465,972, filed on Mar. 2, 2017.

(30) Foreign Application Priority Data
Mar. 27, 2017 (GB) 1704847.1

(51) Int. Cl. G06K 9/00; G06K 19/10; G06K 9/03; G06K 9/42

(52) U.S. Cl. CPC G06K 9/00087; G06K 9/0002; G06K 2209/05; G06K 9/03; G06K 9/42; G06K 19/10

(57) ABSTRACT

A fingerprint sensor system includes a fingerprint area sensor 130 having an array of pixels and a fingerprint processor 128 for processing a signal from the fingerprint area sensor 130. A process for calibration of this system comprises: determining a gain matrix of pixel gain values by performing a scan of the fingerprint area sensor 130 when it is presented with a homogenous target that covers all of the pixels; determining an offset noise matrix of pixel offset noise values by performing a scan of the fingerprint area sensor 130 when nothing is presented to the fingerprint area sensor 130; and arranging the fingerprint processor 128 to store the information from the gain matrix and the offset noise matrix as calibration information and to use this calibration information to correct fingerprint data obtained from the fingerprint area sensor 130 during later use of the fingerprint sensor 130.

### CROSS REFERENCE TO RELATED APPLICATIONS

This application is related to and claims the benefit of U.S. Provisional Patent Application No. 62/465972 filed on Mar. 2, 2017 and Great Britain Patent Application Number 1704847.1 filed on Mar. 27 2017, the contents of both of said applications being incorporated by reference herein in their entirety.

### TECHNICAL FIELD

The present disclosure relates to a process for calibrating a fingerprint sensor system. A method of use of a calibrated fingerprint sensor system, a corresponding fingerprint sensor system and a related computer program product are also disclosed.

### BACKGROUND

Fingerprint authorized devices such as smartcards are becoming increasingly more widely used. Smartcards for which biometric authorization has been proposed include, for example, access cards, credit cards, debit cards, pre-pay cards, loyalty cards, identity cards, and so on. Smartcards are electronic cards with the ability to store data and to interact with the user and/or with outside devices, for example via contactless technologies such as RFID. These cards can interact with sensors to communicate information in order to enable access, to authorize transactions and so on. Other devices are also known that make use of biometric authorization such as fingerprint authorization, and these include computer memory devices, building access control devices, military technologies, vehicles and so on.

Many different techniques are used to obtain an image of the finger including optical scanners, thermal scanners, capacitive scanners, E-field sensors, ultrasonic scanners, and many more. Each uses a different modality or technique to capture certain features of a person's fingerprint. Such features are commonly known as: whorls, loops, arches, and/or tented arches.

### BRIEF SUMMARY

Viewed from a first aspect the disclosure provides a process for calibrating a fingerprint sensor system, the fingerprint sensor system including a fingerprint area sensor having an array of pixels and a fingerprint processor for processing a signal from the fingerprint area sensor, the process comprising: determining a gain matrix of pixel gain values by performing a scan of the fingerprint area sensor when it is presented with a homogenous target that covers all of the pixels; determining an offset noise matrix of pixel offset noise values by performing a scan of the fingerprint area sensor when nothing is presented to the fingerprint area sensor; and arranging the fingerprint processor to store the information from the gain matrix and the offset noise matrix as calibration information and to use this calibration information to correct fingerprint data obtained from the fingerprint area sensor during later use of the fingerprint sensor.

With this process, the fingerprint sensor system can account for any variations in gain and offset noise measured by the pixels of the fingerprint area sensor. The process includes generating calibration matrices for correction of fingerprint data and storing calibration information at the processor. The calibration information may be the matrices themselves or it may be derived from the matrices. For example the calibration information may be a matrix, a database, a function or a transform that can be used to correct fingerprint data obtained by later use of the fingerprint sensor. This enables the system to produce a more accurate and reproducible representation of any fingerprint that is scanned by the fingerprint area sensor. By accounting for any variations in gain and offset noise measured by the pixels, use of the calibration information to correct fingerprint data obtained by later use of the fingerprint sensor also ensures that the fingerprint data is independent of the location or orientation of the fingerprint relative to the area sensor. This enables the system to account for any deviations in fingerprint placement during later use of the fingerprint sensor.

The process may include the step of normalizing the gain matrix. An average gain value may be determined by taking an average of the elements of the gain matrix and each element of the gain matrix may be divided by the average gain value in order to obtain a normalized gain matrix. The average gain value may be determined by taking the mean of the elements of the gain matrix. Preferably the gain matrix has an element for each pixel of the sensor area. It is expected that the variation in pixel gain could be appreciable in between adjacent pixels.

Each pixel of the fingerprint area sensor has a slightly different gain value. The proposed process enables the fingerprint sensor system to account for these differences by determining the gain matrix. If the pixels of the fingerprint area sensor had the same gain value, the gain matrix would be homogeneous since the target is homogenous, i.e. the target may present a homogenous contact area to the area of the fingerprint sensor. Thus, the gain matrix contains information highlighting the differences between the gain values measured by the individual pixels. This information can be used to correct for those differences during later use of the fingerprint sensor.

The homogenous target may comprise a body with a smooth surface, wherein the body is composed of a material that mimics the dielectric properties of the skin, for example the body may be a silicone material. The body of the target may be shaped to be presented to and to cover all pixels of the fingerprint area sensor without any deformation of the body. For example, the target may have a flat surface so that the flat surface covers all pixels of the fingerprint area sensor. Alternatively the body of the target may be shaped to be presented to and to cover all pixels of the fingerprint area sensor with some elastic deformation of the body. In the latter case the body of the target may have a shape similar to a fingertip, i.e. with the smooth surface having a curved shape. In this way the target may more accurately mimic a fingertip, whilst of course having a homogenous surface rather than having fingerprint features such as ridges and whorls.

The offset noise matrix is obtained whilst nothing is presented to the fingerprint area sensor. Thus, there may be nothing but ambient air in contact with the fingerprint area sensor. There may be a clear volume abutting the sensing area, with nothing present within that volume within a certain distance from the sensor, for example nothing within 10 cm or nothing within 20 cm. To achieve this, a grounded metal shield may be positioned a distance away from the sensor, for example at 10 cm or 20 cm away from the sensor.

Each element of the offset noise matrix may represent more than one pixel of the fingerprint area sensor. For example, each element of the offset noise matrix may represent a square of pixels such as a 2×2, 3×3 or 4×4 square of pixels. This has the advantage of saving memory within the fingerprint processor. Unlike pixel gain, offset noise is expected to be similar for adjacent pixels and to differ only slowly across the fingerprint area sensor, thus an offset noise matrix with adjusted dimensions may represent an accurate approximation of the offset noise measured by each pixel.

When a fingerprint is scanned by the fingerprint area sensor during later use of the fingerprint sensor system then a matrix of measured values is created. The fingerprint processor may use the calibration information to correct those measured values. Whilst obtaining the calibration information and/or during correction of fingerprint data the fingerprint processor may be arranged to subtract the offset noise matrix from the matrix of measured values to produce a matrix of measured values minus offset noise. This matrix may then be multiplied by the gain matrix to thereby allow for a correction for both offset noise and pixel gain using the information from the two matrices. For example, if a measured pixel value is 60, the corresponding element of the offset noise matrix is 10 and the corresponding element of the gain matrix is 0.45, the corrected pixel value will be (60−10)×0.45=22.5. The calibration information that is stored at the processor may include information sufficient to perform the calculation described above and thus may comprise the offset noise matrix and the gain matrix, or may comprise a function or transform based on the two matrices, such that the processor uses the function or transform in order to perform the steps of subtracting the offset noise matrix and multiplying by the gain matrix.

The fingerprint processor may be arranged to use the calibration information to correct data obtained during enrolment of a user's fingerprint to the fingerprint sensor system. An example enrolment process may include scanning a user's fingerprint for the first time and storing it for future verification of the user's identification. As is known in the art the enrolment process may involve multiple scans of the user's fingerprint in order to build up a fingerprint template. The fingerprint data that is stored by the fingerprint processor to be used in the future to verify a user's identity is advantageously the corrected fingerprint data, which means that it is independent of the location of the fingerprint relative to the area sensor, and may therefore more accurately match a later scan when the position of the fingerprint is different. The fingerprint processor may also be arranged to use the calibration information to correct fingerprint data obtained during subsequent use of the system by a user for authentication. The processor compares the newly scanned and corrected fingerprint data to the corrected fingerprint data obtained during enrolment. By using the calibration information at both enrolment and authentication, the processor ensures a higher degree of accuracy when determining a user's identity.

Viewed from a second aspect the disclosure provides a method of use of a fingerprint sensor system calibrated in accordance with the first aspect, the method comprising: using the fingerprint area sensor to scan a fingerprint and create a matrix of measured values; and using the calibration information at the fingerprint processor to determine corrected fingerprint data from the matrix of measured values.

The second aspect can also be described as a method of use of a fingerprint sensor system; the fingerprint sensor system including: a fingerprint area sensor having an array of pixels, and a fingerprint processor for processing a signal from the fingerprint area sensor, wherein the processor is provided with calibration information from a gain matrix and an offset matrix, wherein the gain matrix is a matrix obtained by performing a scan of the fingerprint area sensor when it is presented with a homogenous target that covers all of the pixels, and wherein the offset matrix is a matrix obtained by performing a scan of the fingerprint area sensor when nothing is presented to the fingerprint area; and the method comprises: using the calibration information to correct fingerprint data obtained from the fingerprint area sensor during later use of the fingerprint sensor.

The method may include the use of the system and/or processor in accordance with any of the features discussed above in relation to the first aspect. For example, the use of the calibration information may have the effect of subtracting the offset noise matrix from the matrix of measured values to produce a matrix of measured values minus offset noise. The use of the calibration information may further have the effect of multiplying this matrix by the gain matrix to thereby complete a correction for both offset noise and pixel gain using the information from the two matrices.

The step of using the calibration information may be performed at the fingerprint processor as a part of the processing of fingerprint data for enrolling a user and/or for confirming the identity of a user.

The gain and offset noise matrices may be determined as discussed above. The gain matrix may be normalized. An average gain value may be determined by taking an average of the elements of the gain matrix and each element of the gain matrix may be divided by the average gain value in order to obtain a normalized gain matrix. The average gain value may be determined by taking the mean of the elements of the gain matrix. Preferably the gain matrix has an element for each pixel of the sensor area.

Each element of the offset noise matrix may represent more than one pixel of the fingerprint area sensor. For example, each element of the offset noise matrix may represent a square of pixels such as a 2×2, 3×3 or 4×4 square of pixels.

Use of the fingerprint sensor system in accordance with the second aspect enables the fingerprint sensor system to account for any variations in gain and offset noise measured by the pixels of the fingerprint area sensor. The system can therefore produce a more accurate and reproducible representation of any fingerprint that is scanned by the fingerprint area sensor.

The use of the fingerprint sensor system may include using the calibration information to correct data obtained during enrolment of a user's fingerprint to the fingerprint sensor system. An example enrolment process may include scanning a user's fingerprint for the first time and storing it for future verification of the user's identification. As is known in the art the enrolment process may involve multiple scans of the user's fingerprint in order to build up a fingerprint template. The fingerprint data that is stored by the fingerprint processor to be used in the future to verify a user's identity is advantageously the corrected fingerprint data, which means that it is independent of the location of the fingerprint relative to the area sensor, and may therefore more accurately match a later scan when the position of the fingerprint is different.

The use of the fingerprint sensor system may include using the calibration information to correct fingerprint data obtained during subsequent use of the system by a user for authentication. The newly scanned and corrected fingerprint data is compared to the corrected fingerprint data obtained during enrolment. By using the calibration information at both enrolment and authentication, the fingerprint sensor system ensures a higher degree of accuracy when determining a user's identity and enhanced security characteristics. Furthermore, as the corrected fingerprint data is independent of the location of the fingerprint relative to the area sensor, the system is able to more accurately account for deviations in fingerprint placement during enrolment and subsequent authentication.

Viewed from a third aspect the disclosure provides a fingerprint sensor system, the fingerprint sensor system including a fingerprint area sensor having an array of pixels and a fingerprint processor for processing a signal from the fingerprint area sensor, wherein the fingerprint sensor system is arranged to obtain and/or to use calibration information in accordance with the first aspect and/or the second aspect.

The third aspect can also be described as a fingerprint sensor system including: a fingerprint area sensor having an array of pixels; and a fingerprint processor for processing a signal from the fingerprint area sensor, wherein the processor is provided with calibration information from a gain matrix and an offset matrix, wherein the gain matrix is a matrix obtained by performing a scan of the fingerprint area sensor when it is presented with a homogenous target that covers all of the pixels, and wherein the offset matrix is a matrix obtained by performing a scan of the fingerprint area sensor when nothing is presented to the fingerprint area; and wherein the fingerprint processor is arranged to store the calibration information and/or is arranged to use the calibration information to correct fingerprint data obtained from the fingerprint area sensor during later use of the fingerprint sensor.

The fingerprint sensor system may take the form of a calibration system for configuring a fingerprint processor and the associated fingerprint area sensor for later use with a different system or device. Thus, the fingerprint sensor system may be used for calibration purposes, i.e. performing a method as in the first aspect, with the fingerprint area sensor and fingerprint processor then being used in a separate device for subsequent enrolment and authorization using newly obtained fingerprint data and the stored calibration information. Alternatively the fingerprint sensor system may take the form of a fingerprint protected device in which the calibration information is used after having been provided from a calibration step carried out previously. Thus, the fingerprint sensor system may be a part of a device such as a smartcard as set out below, and this device may be calibrated by a separate system during manufacture. In a still further alternative the fingerprint sensor system may be a system that self-calibrates, i.e. a system that performs both of the calibration method of the first aspect and also the later use of calibration information as in the second aspect. This may again be in the context of a device such as a smartcard as set out below.

The fingerprint sensor system of the third aspect may have any of the other features discussed above in connection with the first aspect and/or the second aspect.

The fingerprint sensor system may be arranged to use the calibration information to correct data obtained during enrolment of a user's fingerprint to the fingerprint sensor system. An example enrolment process may include scanning a user's fingerprint for the first time and storing it for future verification of the user's identification. As is known in the art the enrolment process may involve multiple scans of the user's fingerprint in order to build up a fingerprint template. The fingerprint data that is stored by the fingerprint processor to be used in the future to verify a user's identity is advantageously the corrected fingerprint data, which means that it is independent of the location of the fingerprint relative to the area sensor, and may therefore more accurately match a later scan when the position of the fingerprint is different. The fingerprint sensor system may also be arranged to use the calibration information to correct fingerprint data obtained during subsequent use of the system by a user for authentication. The newly scanned and corrected fingerprint data is compared to the corrected fingerprint data obtained during enrolment. By using the calibration information at both enrolment and authentication, the fingerprint sensor system ensures a higher degree of accuracy when determining a user's identity.

Viewed from a fourth aspect, the disclosure provides a computer program product for use with a fingerprint sensor system including: a fingerprint area sensor having an array of pixels, and a fingerprint processor for processing a signal from the fingerprint area sensor; the computer program product containing instructions that when executed will configure the fingerprint sensor system to perform the method of the first aspect and/or the method of the second aspect. Thus, the computer program product may contain instructions that when executed will configure the fingerprint sensor system to obtain the gain matrix and offset matrix and thereafter to store the calibration information. The computer program product may alternatively or additionally contain instructions that when executed will configure the fingerprint sensor system to use the calibration information in order to correct fingerprint data obtained during use of the fingerprint sensor.

The fingerprint sensor system of any of the above aspects may include features as discussed below.

The fingerprint sensor system may be arranged so that it is impossible to extract the fingerprint data used for identifying users via fingerprint authorization. This data may be a fingerprint template or the like. To avoid any need for communication of the fingerprint data outside of the fingerprint sensor system then the fingerprint sensor system may be able to self-enrol, i.e. the fingerprint processor may be arranged to enrol an authorized user by obtaining fingerprint data via the fingerprint sensor. This also has advantages arising from the fact that the exact same sensor with the same geometry is used for the enrolment as for the fingerprint authorization. The fingerprint data can be obtained more consistently in this way compared to the case where a different sensor on a different fingerprint sensor system is used for enrolment. With fingerprint biometrics, one problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced.

Thus, in accordance with the proposed fingerprint sensor system, both the matching and enrolment scans may be performed using the same fingerprint sensor. As a result, scanning errors can be balanced out because, for example, if a user tends to present their finger with a lateral bias during enrolment, then they are likely to do so also during matching.

Alternatively, the user's fingerprint data may be enrolled with the fingerprint sensor system via another device, which may for example be a computer device arranged for securely obtaining fingerprint data and securely transmitting it to the fingerprint sensor system. The computer device may include or be a part of a data transmission network. It may include a smartphone.

It will be appreciated that a fingerprint sensor as described herein is capable of taking a scan of any digit, including a thumb as well as a finger. It is common in this field to refer mainly to “finger” and to “fingerprint” when it is understood that a thumb/thumbprint could readily be substituted. Hence, any reference herein to a fingerprint sensor and obtaining fingerprint scans/data should be seen as also encompassing the use of a thumb in place of the finger.

The fingerprint processor may include a processor for executing the fingerprint matching algorithm and a memory for storing fingerprint data for enrolled fingerprints. The fingerprint sensor system may include multiple processors, wherein the fingerprint processor may be a separate processor associated with the fingerprint sensor. Other processors of the fingerprint sensor system may include a control processor for controlling basic functions of the fingerprint sensor system, such as communication with other devices (e.g. via contactless technologies), activation and control of receivers/transmitters, activation and control of secure elements such as for financial transactions and so on. The various processors could be embodied in separate hardware elements, or could be combined into a single hardware element, possibly with separate software modules.

The fingerprint sensor system may be a part of a portable device, by which is meant a device designed for being carried by a person, preferably a device small and light enough to be carried conveniently. In this case the fingerprint sensor may be used to identify authorized users of the device, with the device being arranged to permit access to features of the device in response to identification of an authorized user via the fingerprint sensor. The device can be arranged to be carried within a pocket, handbag or purse, for example. The device may be a smartcard such as a fingerprint author sable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

Where the device is a smartcard then smartcard may be any one of: an access card, a credit card, a debit card, a pre-pay card, a loyalty card, an identity card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to fingerprint identification of an authorized user. Alternatively the control token may act as a remote locking type key, with the signal for unlocking the vehicle only being able to be sent if the fingerprint authorization module identifies an authorized user. In this case the identification of the authorized user may have the same effect as pressing the unlock button on prior art keyless entry type devices, and the signal for unlocking the vehicle may be sent automatically upon fingerprint identification of an authorized user, or sent in response to a button press when the control token has been activated by authentication of an authorized user.

The device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

### BRIEF DESCRIPTION OF THE DRAWINGS

Certain preferred embodiments on the present disclosure will now be described in greater detail, by way of example only and with reference to the accompanying drawings, in which:

FIG. 1 illustrates a circuit for a smartcard with a fingerprint sensor;

FIG. 2 shows an example of a smartcard with an external housing; and

FIG. 3 shows an example laminated type smartcard.

### DETAILED DESCRIPTION

By way of example the disclosure is described in the context of fingerprint authorized smartcards that include contactless technology and use power harvested from the card reader. These features are envisaged to be advantageous features of one application of the proposed method but they are not seen as essential features. A smartcard may alternatively use a physical contact pad for communications and/or power supply. It may also optionally include a battery providing internal power. In addition, the calibration method described herein may be applied without any substantial change to devices other than smartcards.

In the example shown in the Figures a capacitive type fingerprint sensor 130 is used to generate an image of a user's fingerprint which is used to authorize use of fingerprint protected smartcard 102. The sensor 130 produces an image of the fingerprint by requiring the user to place their finger on the surface of the sensor 130. The degree to which the fingerprint is close to the sensor surface is measured microscopically by modulating the finger with a high frequency signal (−150 Khz in a typical sensor) which couples to the sensor surface to a degree which is a function of the distance.

The fingerprint sensor 130 is an area sensor that is divided up across its axes into pixels, each pixel having an electronic sensor element which connects the pixel voltage to an amplifier. The amplifier is connected to an A/D converter. The sensor electronics scans all of the pixels on the surface of the sensor and the output of the A/D converter is stored in a digital map representing the voltages measured across the expanse of the sensor. This map represents the fingerprint with its characteristic patterns.

Each pixel has a slightly different gain and offset which contributes to image noise. In order to produce an image devoid of noise, the fingerprint sensor 130 is put through a calibration routine during the manufacturing process. First, a plain finger-like “target” is placed on the fingerprint sensor 130. This target has a smooth surface and has material characteristics similar to a live finger. For example, the target may be a silicone rubber body shaped and sized like a typical finger, but with a flat surface for presenting to the fingerprint sensor 130. However, it lacks any of the ridge and valley features of an actual fingerprint and fits fully into the sensor area, covering all of the pixels evenly without deformation of the target. The fingerprint sensor 130 is scanned and the pixel values are put into non-volatile memory on the device. This produces a matrix of values corresponding to the measured values for each pixel. Since the target presents a homogenous surface to the entire fingerprint sensor 130 then the values from each pixel would be identical if all of the pixels were perfect. In practice there are small variations in the pixel values since the individual pixels can have differing gain values. In effect, a scan that should be representable as a uniform shade of grey would have a mottled appearance. The aim of the first calibration scan using the target is to allow for correction of the gain values.

A gain matrix, i.e. a matrix indicative of the gain values for each pixel is obtained by normalizing the matrix of measured values obtained in the first calibration scan. To normalize the gain values an average gain value is determined as the mean average of all of the gain values measured for each pixel and then each value in the matrix is divided by the average gain value. The resulting normalized gain matrix is effectively a transform that will correct for any variations in pixel gain across the area of the fingerprint sensor 130. The original scan of the target may show a variation in pixel value due to varying pixel gain. The normalized gain matrix can produce a corrected scan when applied as a transform to the original pixel values, and the output would be a new scan where all pixels take the same value, i.e. where the effect is to allow the scan to be shown as the uniform shade of grey that should be produced by the target.

A second calibration scan is performed with nothing at all on the surface of the fingerprint sensor 130. There might be a clear space containing only ambient air for at least 10 cm or at least 20 cm from the sensor surface in order to ensure that the sensor 130 sees “nothing”. A grounded metal shield can be positioned a distance away from the sensor, for example at 10 cm or 20 cm away from the sensor, in order to avoid any interference. The fingerprint sensor 130 is scanned and the pixel values are put into non-volatile memory. This produces a second matrix containing values indicative of offset noise for each pixel, i.e. an indication of the noise generated for all readings taken by the pixel. The offset noise matrix could be recorded in the same manner as the gain matrix above, with values for every pixel. However, it is believed that the offset noise will be similar for nearby pixels and will only change slowly across the face of the pixels. Consequently in order to save memory, the dimensions of the offset noise matrix may be altered so that each element of this matrix can represent up to 16 pixels (4×4 pixels) of the fingerprint sensor 130.

The gain matrix and the offset noise matrix are used as calibration matrices and they provide calibration information that is used by the fingerprint processor 128 for adjusting each pixel reading in real time during later use of the fingerprint sensor 130. The calibration information is used during enrolment and also used when a user authenticates their fingerprint for comparison to the enrolled template that is stored in the device's microprocessor. During use, when an image of a fingerprint is scanned by the fingerprint sensor 130, a matrix of measured values is created representing the characteristic patterns of that particular fingerprint. In order to account for sensor noise and for pixel gain variations the calibration information is used by the fingerprint processor 128 to correct the measured values. The use of the calibration information has the effect that the calibration offset noise matrix is subtracted from the matrix of measured values.

The result is then multiplied by the normalized gain matrix to correct for the variation in pixel gain. This produces a matrix of pixel values devoid of noise and corrected for gain variations. As a consequence a more accurate and reproducible representation of the fingerprint can be produced, therefore enhancing the device's security. It will be appreciated that the two matrices may be used directly as the calibration information and hence they may be stored at the fingerprint processor 128. Alternatively the calibration information stored at the fingerprint processor 128 may be information derived from the matrices, but not identical to them. For example it may be a function or a transform for applying the require correction according to the calibration matrices.

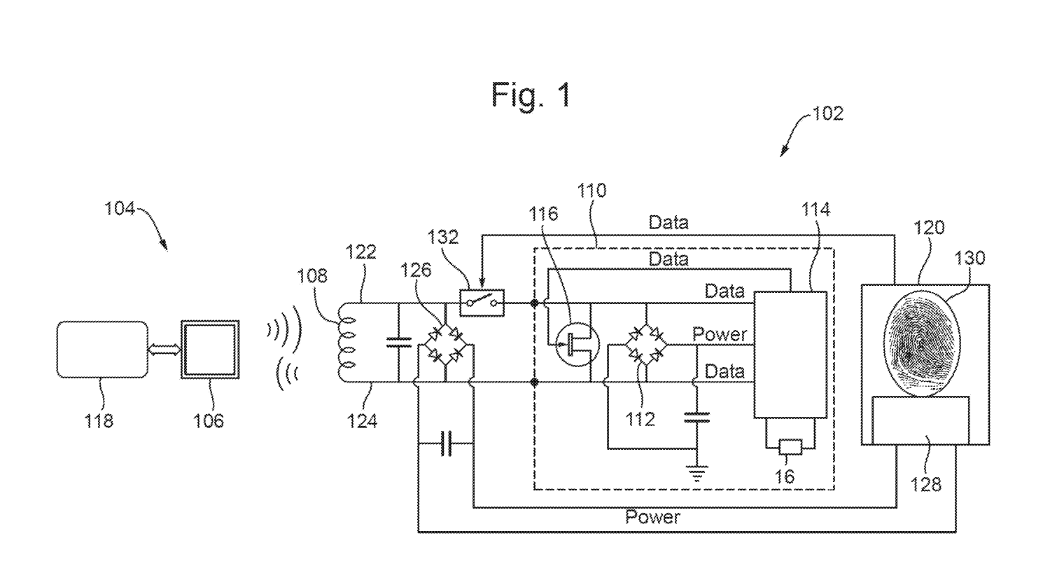

FIG. 1 shows the architecture of an example contactless smartcard 102 that can incorporate the calibration matrices described above. The smartcard 102 can be calibrated during manufacture with the calibration matrices then being stored on the smartcard 102 for use during later fingerprint authentication.

In the smartcard 102 of FIG. 1, a powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signaling is known as backscatter modulation and is characterized by the fact that the sensor 104 is used to power the return message to itself.

An accelerometer 16, which is an optional feature, is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required operating modes on the card as discussed below. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

The smartcard includes a fingerprint authentication engine 120 with a fingerprint processor 128 and the fingerprint sensor 130. This allows for enrolment and authorization via fingerprint identification. The fingerprint processor 128 and the processor 114 that controls the communication chip 110 together form a control system for the device. The two processors could in fact be implemented as software modules on the same hardware, although separate hardware could also be used. As with the accelerometer 16 (where present) the fingerprint sensor 130 may be used only when power is being harvested from the powered card reader 104, or alternatively the smartcard 102 may be additionally provided with a battery (not shown in the Figures) allowing power to be provided at any time for the fingerprint sensor 130 and fingerprint processor 128, as well as the processor 114 and other features of the device.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120.

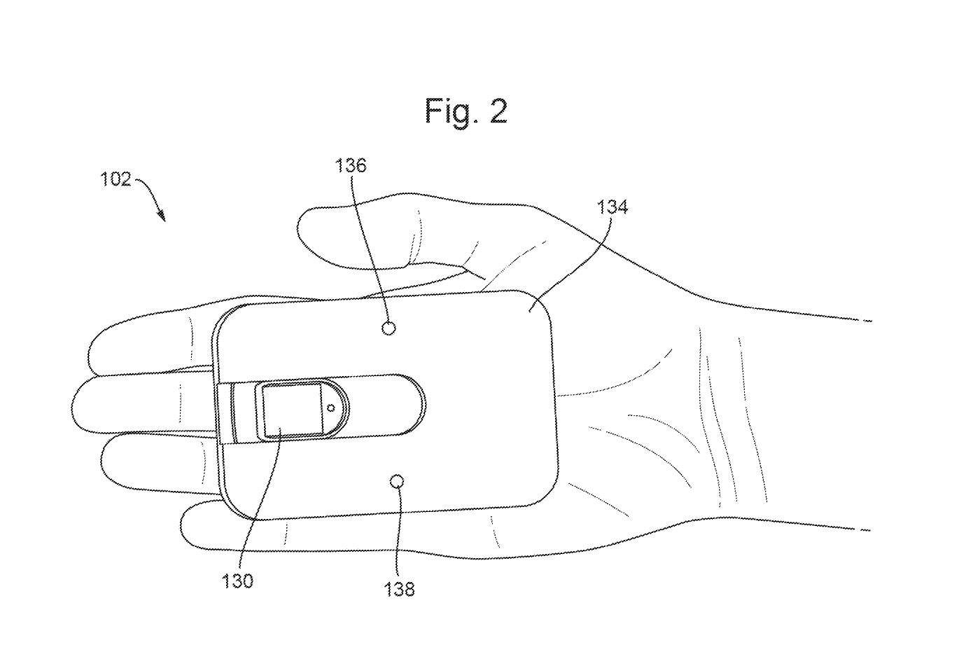

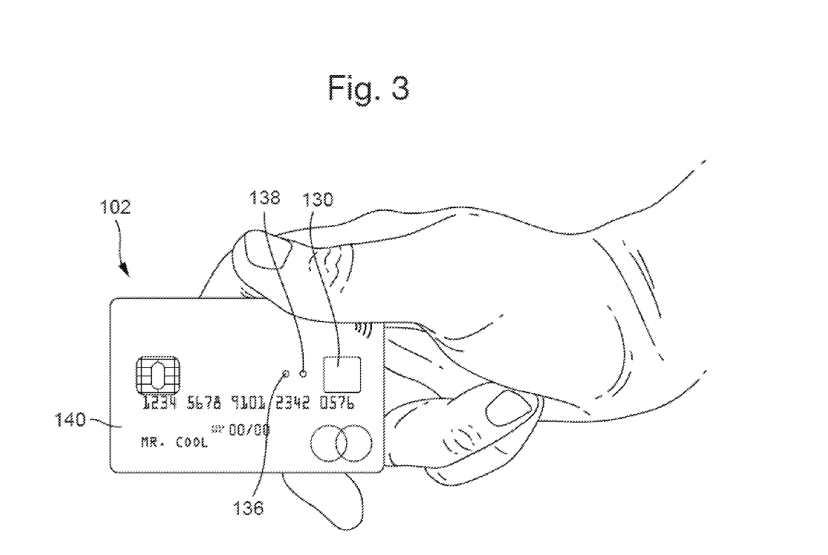

The fingerprint sensor 130 of the fingerprint authorization engine, which is an area fingerprint sensor 130, may be mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards.

The fingerprint authentication engine 120 can be passive, and hence powered only by the voltage output from the antenna 108, although the smartcard 102 may also include a battery as mentioned above. The battery can power the fingerprint authentication engine 120 as well as other processors and user interfaces such as the graphical user interface 18, the accelerometer 16 and the LEDs 136, 138. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor 130 and to compare the scanned fingerprint of the finger or thumb to pre-stored fingerprint data using the processor 128. A determination is then made as to whether the scanned fingerprint matches the pre-stored fingerprint data. During this process the scanned fingerprint is corrected using the calibration matrices described above, with the corrected scan providing for fingerprint data that is used in the subsequent comparison with the pre-stored fingerprint data. In a preferred embodiment, the time required for capturing a fingerprint image and authenticating the bearer of the card 102 is less than one second. It will be appreciated that the application of the two matrices can be very quick as the calculation is a simple one, so the added accuracy from calibration can be used without any significant disadvantage in terms of fingerprint processing time.

If a fingerprint match is determined then the processor takes appropriate action depending on its programming. In this example the fingerprint authorization process is used to authorize the use of the smartcard 104 with the contactless card reader 104. Thus, the communication chip 110 is authorized to transmit a signal to the card reader 104 when a fingerprint match is made. The communication chip 110 transmits the signal by backscatter modulation, in the same manner as the conventional communication chip 110. The card may provide an indication of successful authorization using a suitable indicator, such as a first LED 136.

The processor 114 receives the output from the accelerometer 16, where present, and this allows the processor 114 to determine what movements of the smartcard 102 have been made. The processor 114 can then identify pre-set movements and other actions of the user that can be linked with required changes to the operating mode of the smartcard.

The operating modes that the processor 114 activates or switches to in response to an identified movement associated with the required change in operating mode may include turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, Wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102. The accelerometer 16 could also be used in relation to triggering an enrolment cancelling unction of the smartcard 102 as discussed below.

The processor 114 has an enrolment mode, which may be activated upon first use of the smartcard 102. In the enrolment mode the user is prompted to enrol their fingerprint data via the fingerprint sensor 130. This can require a repeated scan of the fingerprint via the fingerprint sensor 130 so that the fingerprint processor 128 can build up appropriate fingerprint data, such as a fingerprint template. During enrolment via the fingerprint sensor 130 the fingerprint data is corrected via the calibration matrices before it is used to build up the fingerprint data. This produces a more accurate fingerprint template since the differences in pixel gain at different points on the sensor area will not result in differences in the appearance of fingerprint features when the fingertip is placed in differing locations. The fingerprint data could alternatively be provided to the smartcard 102 from an external device, with suitably secure communications between the external device and the smartcard 102.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A process for calibrating a fingerprint sensor system, the fingerprint sensor system including a fingerprint area sensor having an array of pixels and a fingerprint processor for processing a signal from the fingerprint area sensor, the process comprising:
determining a gain matrix of pixel gain values by performing a scan of the fingerprint area sensor when it is presented with a homogenous target that covers all of the pixels;
determining an offset noise matrix of pixel offset noise values by performing a scan of the fingerprint area sensor when nothing is presented to the fingerprint area sensor; and
arranging the fingerprint processor to store information from the gain matrix and the offset noise matrix as calibration information and to use the calibration information to correct the fingerprint data obtained from the fingerprint area sensor during later use of the fingerprint sensor.

2. A process as claimed in claim 1, comprising correcting the fingerprint data obtained from the fingerprint area sensor during later use of the fingerprint sensor system by:
creating a matrix of measured values from the fingerprint data;
using the calibration information to create a corrected matrix of measured values in which the offset noise matrix is subtracted from the matrix of measured values and the result is multiplied by the gain matrix.

3. A process as claimed in claim 1, wherein determining the gain matrix further comprises normalizing the gain matrix.

4. A process as claimed in claim 3, wherein normalizing the gain matrix includes determining an average gain value by taking an average of the elements of the gain matrix, and dividing each element of the gain matrix by the average gain value.

5. A process as claimed in claim 1, wherein the gain matrix has an element for each pixel of the sensor area.

6. A process as claimed in claim 1, wherein the homogenous target comprises a body with a smooth surface, and wherein the body is formed of a material that mimics the dielectric properties of the skin.

7. A process as claimed in claim 1, wherein each element of the offset noise matrix represents more than one pixel of the fingerprint area sensor.

8. A process as claimed in claim 7, wherein each element of the offset noise matrix represents a 2×2 square of pixels, a 3×3 square of pixels, or a 4×4 square of pixels.

9. A process as claimed in claim 1, comprising using the calibration information to correct fingerprint data obtained during enrolment of a user's fingerprint to the fingerprint sensor system.

10. A process as claimed in claim 1, comprising using the calibration information to correct fingerprint data obtained during use of the sensor by a user for authentication.

11. A method of use of a fingerprint sensor system calibrated as claimed in claim 1, the method comprising:
using the fingerprint area sensor to scan a fingerprint and create a matrix of measured values; and
using the calibration information at the fingerprint processor to determine corrected fingerprint data from the matrix of measured values.

12. A method of use of a fingerprint sensor system as claimed in claim 11, wherein the fingerprint processor is arranged to use the calibration information to create a corrected matrix of measured values in which the offset noise matrix is subtracted from the matrix of measured values and the result is multiplied by the gain matrix.

13. A method as claimed in claim 11, wherein the calibration information is used to correct fingerprint data obtained during enrolment of a user's fingerprint.

14. A method as claimed in claim 11, wherein the calibration information is used to correct fingerprint data obtained during use of the sensor by a user for authentication.

15. A fingerprint sensor system comprising:
a fingerprint area sensor having an array of pixels; and
a fingerprint processor for processing a signal from the fingerprint area sensor;
wherein the fingerprint sensor system is arranged to obtain and/or to use calibration information in accordance with the method of claim 1.

16. A fingerprint sensor system including:
a fingerprint area sensor having an array of pixels; and
a fingerprint processor for processing a signal from the fingerprint area sensor, wherein the processor is provided with calibration information from a gain matrix and an offset matrix, wherein the gain matrix is a matrix obtained by performing a scan of the fingerprint area sensor when it is presented with a homogenous target that covers all of the pixels, and wherein the offset matrix is a matrix obtained by performing a scan of the fingerprint area sensor when nothing is presented to the fingerprint area; and
wherein the fingerprint processor is arranged to store the calibration information and/or is arranged to use the calibration information to correct fingerprint data obtained from the fingerprint area sensor during later use of the fingerprint sensor.

17. A smartcard comprising a fingerprint sensor system as claimed in claim 16, wherein the smartcard is arranged to use the fingerprint sensor system to identify authorized users of protected features of the smartcard.

18. A computer program product for use with a fingerprint sensor system including: a fingerprint area sensor having an array of pixels, and a fingerprint processor for processing a signal from the fingerprint area sensor; the computer program product containing instructions that when executed will configure the fingerprint sensor system to perform the method of claim 1.
